(19) United States
(12) Patent Application Publication
(10) Pub. No.: US 2008/0288343 A1
(43) Pub. Date: Nov. 20, 2008

(54) Method and System to Process Digital Media Product Codes

(75) Inventors: Chi Fai Ho, Palo Alto, CA (US); Shin Cheung Simon Chiu, Palo Alto, CA (US)

Correspondence Address: Michele Baillie, P.O BOX 683, MARBLEHEAD, MA, 01945, US

(73) Assignee: TP LAB, Palo Alto, CA (US)

(21) Appl. No.: 11/749,050

(22) Filed: May 15, 2007

(51) Int. Cl. G06Q 30/00

(52) U.S. Cl. 705/14; 705/26

(57) ABSTRACT

Systems and methods for processing digital media product codes. In one aspect, purchased digital media comprising a digital media product code is sent to a customer. In another aspect, purchased digital media comprising a digital media product code is received from a merchant. In another aspect, digital media is registered using digital media product codes. In another aspect, digital media rebates are processed using digital media product codes. In another aspect, digital media returns are processed using digital media product codes. In another aspect, digital media promotional items are processed using digital media product codes. In another aspect, a system having a storage element and a controller processes digital media comprising a digital media product code.

### BACKGROUND

1. Field

The field of the present invention relates generally to digital media, and particularly to systems and methods to process product codes for digital media.

2. Related Art

Product returns, exchanges, registrations, rebates and promotional items are well established and important commercial processes. Customers benefit from promotional price reduction, product support, and the peace of mind that they can return a product for money or credit for any reason. From the merchants' perspective, such commercial processes are important marketing tools to provide incentives for the customers to purchase their products, and to enhance brand recognition and foster customer loyalty.

These processes are predicated on information associated with the product and the purchase transaction. For example, a Universal Product Code (UPC) on the packaging material of the product serves as proof of possession, and a receipt as proof of purchase. The success is evident as these practices are extended from traditional retail merchants, phone catalogs or mail ordering, to online e-commerce retail sites.

However, extending the same practices to online digital media, such as music download purchasing, poses a unique challenge. The music, purchased as a file of digital representation, such as an MPEG Layer 3 (MP3) file, Advanced Audio Codec (AAC) file, or Windows Media Audio (MWA) file, lacks a product code that is essential to the implementation of the above mentioned commercial processes.

In one example, after purchasing a song and downloading an MP3 file of the song from an online music store, Paul is not happy with the audio quality and decides to return the song. Unfortunately, without a product code, Paul cannot provide proof of possession. In another example, Anna does not like the song that she purchases from the online music store. She is furious when she finds out from the store that it has no return policy for download purchase.

In another example, the marketing executives of the online music download website want to offer a cash rebate to promote a newly released album by Celine Dion. They are dismayed to find out that without a product code, there is no feasible way to implement such offer.

The above illustrates a need for product codes for digital media.

### SUMMARY

Systems and methods are disclosed for processing digital media product codes. In one embodiment, a method sends purchased digital media to a customer, the digital media comprising a digital media product code. In one embodiment, a method receives purchased digital media from a merchant, the digital media comprising a digital media product code. In one embodiment, a method is disclosed for registering digital media, the digital media comprising a digital media product code. In one embodiment, a method is disclosed for processing digital media rebates using digital media product codes. In one embodiment, a method is disclosed for processing digital media returns using digital media product codes. In one embodiment, a method is disclosed for processing digital media promotional items using digital media product codes. In one embodiment, a system having a storage element and a controller is disclosed for processing digital media comprising a digital media product code.

### BRIEF DESCRIPTION OF DRAWINGS

The drawings illustrate the design and utility of embodiments of the present invention, in which similar elements are referred to by common reference numerals. In order to better appreciate the advantages and objects of the embodiments of the present invention, reference should be made to the accompanying drawings that illustrate these embodiments. However, the drawings depict only some embodiments of the invention, and should not be taken as limiting its scope. With this caveat, embodiments of the invention will be described and explained with additional specificity and detail through the use of the accompanying drawings in which:

FIG. 1 is a diagram illustrating a system and method for processing digital media product codes, in accordance with an embodiment of the present invention.

FIG. 2 is a diagram illustrating a system and method for registering purchased digital media, in accordance with an embodiment of the present invention.

FIG. 3 is a diagram illustrating a system and method for processing a digital media rebates, in accordance with an embodiment of the present invention.

FIG. 4 is a diagram illustrating a system and method for processing digital media return merchandize, in accordance with an embodiment of the present invention.

FIG. 5 is a diagram illustrating a system and method for processing promotional items based on digital media product codes, in accordance with an embodiment of the present invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments. In general, features described in one embodiment might be suitable for use in other embodiments as would be apparent to those skilled in the art.

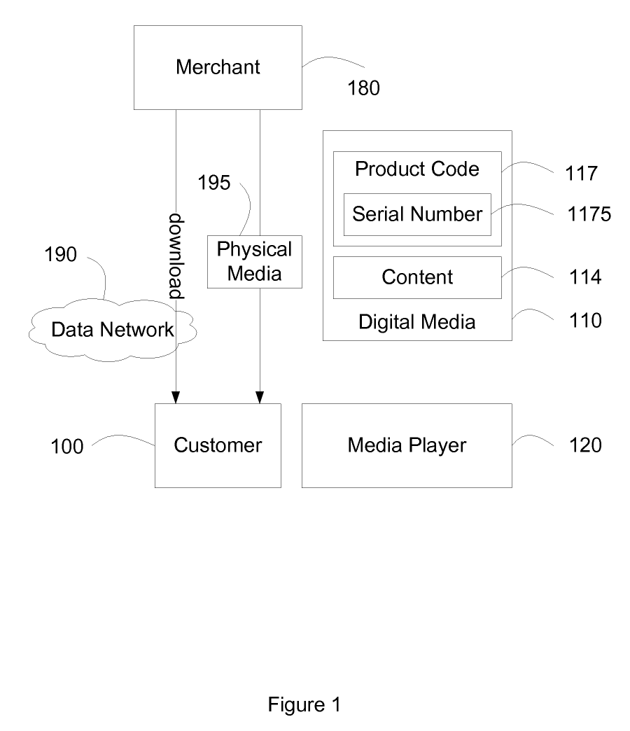

FIG. 1 is a block diagram illustrating a system and method for processing digital media product codes. Customer 100 purchases digital media 110 from merchant 180. As used herein, a purchase is understood to also include renting, leasing and licensing digital media from a merchant, wherein the customer doesn't necessarily hold title to the digital media content. In one embodiment, customer 100 downloads digital media 110 over data network 190. In one embodiment, data network 190 includes the Internet. In one embodiment, data network 190 includes a service provider data network, such as a cable broadband network or a Digital Subscriber Line (DSL) broadband network. In one embodiment, data network 190 includes a wireless data access network, such as General Packet Radio Service (GPRS) network, CDMA2000 network, or third-generation (3G) network. In one embodiment, data network 190 includes a hotspot WiFi network.

In one embodiment, merchant 180 packages digital media 110 with other purchased digital media on a physical media 195. In one embodiment, physical media 195 is a portable memory element, a portable drive, a memory card, or any other physical media for storing digital information. Examples include a Universal Serial Bus (USB) drive, a Secure Digital (SD) card, or any Flash memory card. In one embodiment, customer 100 requests merchant 180 to deliver digital media 110 and other purchases on physical media 195. Other embodiments of physical media 195 include Memory Stick Duo, video tape, hard disk, DVD, or compact disc (CD).

In one embodiment, customer 100 purchases digital media 110 from a retail store, a mail order or phone order company, or an electronic commerce (e-commerce) retail store. In one embodiment, customer 100 receives digital media 110 as a gift. In one embodiment, merchant 180 sells digital media 110 through a broadcast channel, such as a cable broadcast channel, or a radio broadcast channel.

Digital media 110 includes content 114. In one embodiment, content 114 includes audio content such as a song, a piece of music, or a movie sound track. In one embodiment, the audio content is encoded in MPEG Layer 3 (MP3) format, Windows™ Media Audio (WMA) format, Advanced Audio Coding (AAC) format, or any other format for digitally encoding audio information.

In one embodiment, content 114 includes video content such as a movie, a TV program, or a music video. In one embodiment, the video content is encoded in an MPEG-1, MPEG-2 or MPEG-4 format. In one embodiment, the video content is encoded in Windows™ Media Video, or Adobe™ Flash format. In one embodiment, the video content 114 includes images such as a photo, a picture, or an image encoded in Joint Photographic Expert Group (JPEG) format, Graphics Interchange Format (GIF) format, Portable Network Graphics (PNG) format, Scalable Vector Graphics (SVG) format, or any other digital image format. In one embodiment, content 114 includes an album of one or more songs, a volume of one or more movies or TV programs, an album of one or more images, or a collection of one or more images, audio content, and video content.

Customer 100 plays digital media 110 using media player 120. In one embodiment media player 120 is a software program running on a computing device, such as a desktop or laptop personal computer. In one embodiment, the software program is Windows Media Player, Wimamp, Real Player, Musicmatch Jukebox, QuickTime, or iTunes. In one embodiment, media player 120 is a set-top box. In one embodiment, media player 120 is an MP3 player. Examples of MP3 players include Apple's iPod, Toshiba's Gigabeat MEGF40S or Microsoft's Zune. In one embodiment, media player 120 is a mobile phone capable of playing digital media 110 such as smartphones or mobile music phones. Examples of mobile music phones include LG's Chocolate, Nokia's N91, or Sony Ericsson's W810i Walkman phone. Media player 120 connects to output modules such as a display, a speaker, a television, or a monitor to play the image, audio or video content included in content 114.

Digital media 110 comprises product code 117 encoded within the digital media 110. Product code 117 is a code representing digital media 110 as a product for merchant 180. In one embodiment, product code 117 includes a Universal Product Code (UPC). In one embodiment, product code 117 includes a sequence of digits, characters, or alpha-numeric characters. In one embodiment, product code 117 includes an image of a stacked barcode or a matrix barcode, also known as two-dimensional (2D) barcode. Merchant 180 uses product code 117 to identify the digital media 110 product from other products. In one embodiment, product code 117 includes a serial number 1175. In one embodiment, serial number 1175 is a unique code assigned to digital media 110. Merchant 180 uses serial number 1175 of product code 117 to distinguish the digital media 110 product from another digital media 110 products.

Media player 120 displays product code 117 on a display screen. In one embodiment, media player 120 connects to a printer and prints product code 117. In a scenario, media player 120 prints product code 117 as proof of purchase. In one embodiment, after media player 120 prints product code 117 as proof of purchase, product code 117 can no longer be printed as proof of purchase.

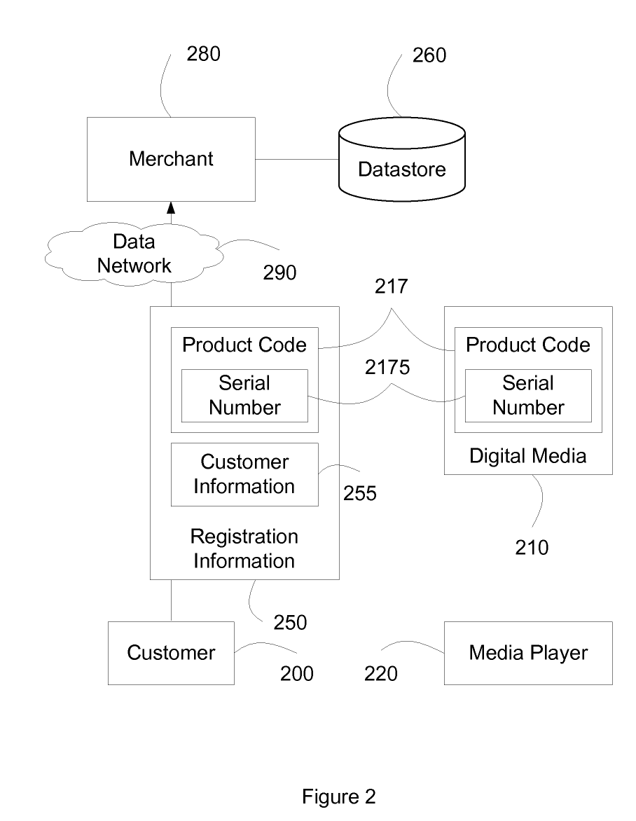

FIG. 2 illustrates a process to register a purchased digital media.

Digital media 210 includes product code 217. After customer 200 purchases digital media 210 from merchant 280, customer 200 obtains product code 217 from media player 220.

Customer 200 provides registration information 250 to merchant 280. Registration information 250 includes product code 217 and customer information 255, such as customer name, an address, an email address and other demographics information. In one embodiment, customer 200 sends registration information 250 to merchant 280 over data network 290. In one embodiment, customer 200 sends registration information 250 using media player 220. In another embodiment, customer 200 prints product code 217 and mails registration information 250 to merchant 280.

Merchant 280 includes datastore 260. Datastore 260 includes a plurality of product codes and a plurality of registration information. Merchant 280 receives registration information 250. Merchant 280 matches product code 217 in registration information 250 against the plurality of product codes in datastore 260 to confirm that product code 217 is a valid product sold by merchant 280. In one embodiment product code 217 includes serial number 2175. In one embodiment, merchant 280 matches serial number 2175 against the plurality of registration information in datastore 260 to confirm that there is no matching registration information stored in datastore 260. Merchant 280 then stores registration information 250 into datastore 260.

In one embodiment, customer 200 registers digital media 210 with merchant 280 for product warranty. In one embodiment, customer 200 registers digital media 210 for product support. In one embodiment, merchant 280 uses registration information 250 to contact customer 200 for future product promotion.

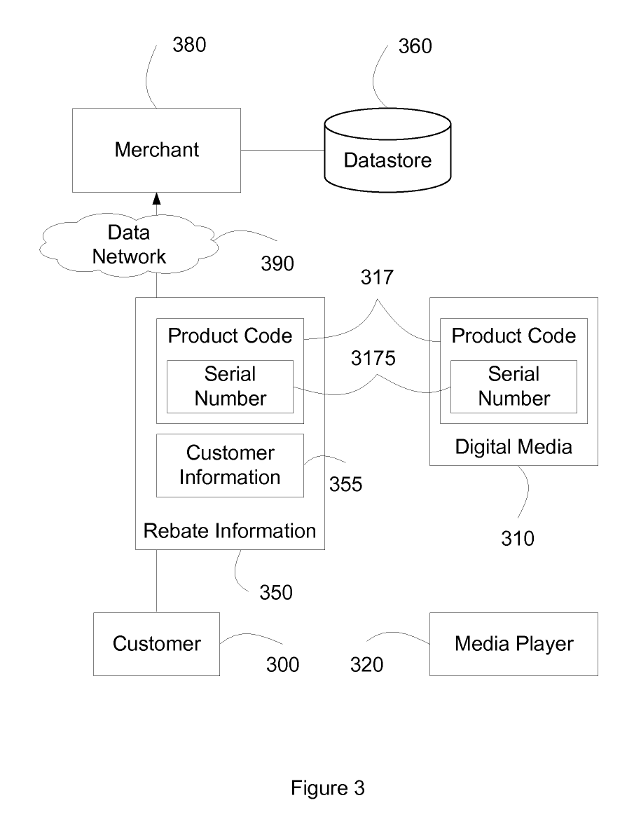

FIG. 3 illustrates a process to handle a rebate for a digital media.

Digital media 310 includes product code 317. After customer 300 purchases digital media 310 from merchant 380, customer 300 obtains product code 317 from media player 320.

Customer 300 provides rebate information 350 to merchant 380. Rebate information 350 includes product code 317 and customer information 355, such as customer name, a mailing address, date of purchase, credit card or bank account information. In one embodiment, customer 300 sends rebate information 350 to merchant 380 over data network 390. In one embodiment, customer 300 sends rebate information 350 using media player 320. In another embodiment, customer 300 prints product code 317 as proof of purchase and mails rebate information 350 to merchant 380.

Merchant 380 includes datastore 360. Datastore 360 includes a plurality of product codes and a plurality of rebate information. Merchant 380 receives rebate information 350. Merchant 380 matches product code 317 in rebate information 350 against the plurality of rebate information in datastore 360 to confirm that product code 317 is a valid product sold by merchant 380. In one embodiment product code 317 includes serial number 3175. In one embodiment, merchant 380 matches serial number 3175 against datastore 360 to confirm there is no matching rebate information 350 stored in datastore 360. Merchant 380 then stores rebate information 350 into datastore 360. In one embodiment, datastore 360 includes a plurality of registration information; merchant 380 confirms that customer information 355 and product code 317 correspond to a valid registration.

Merchant 380 proceeds to deliver the rebate monetary amount to customer 300. In one embodiment, merchant 380 generates a check for the rebate monetary amount and mails the check to customer 300, using the mailing address in customer information 355. In another embodiment, merchant 380 conducts an electronic fund transfer for the rebate monetary amount using credit card or bank account information in customer information 355.

In a similar embodiment, the rebate is offered by the manufacturer of digital media 310; customer 300 sends rebate information 350 to the manufacturer. In one embodiment, customer 300 sends rebate information 350 to a rebate clearing house or a rebate processing center.

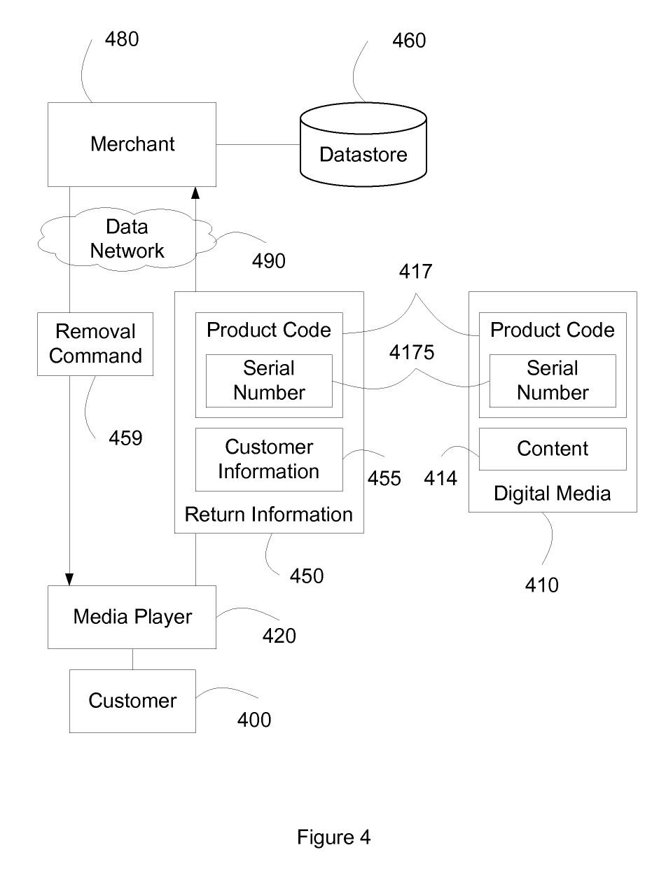

FIG. 4 illustrates a process to handle a return merchandise for a digital media.

Digital media 410 includes product code 417 and content 414. After customer 400 purchases digital media 410 from merchant 480, customer 400 obtains product code 417 from media player 420.

Customer 400 provides return information 450 to merchant 480. Return information 450 includes product code 417 and customer information 455, such as customer name, a mailing address, date of purchase, credit card or bank account information, and a reason for the return. In one embodiment, customer 400 sends return information 450 to merchant 480 over data network 490 using media player 420.

Merchant 480 includes datastore 460. Datastore 460 includes a plurality of product codes and a plurality of return information. Merchant 480 receives return information 450. Merchant 480 matches product code 417 in return information 450 against the plurality of return information in datastore 460 to confirm that product code 417 is a valid product sold by merchant 480. In one embodiment product code 417 includes serial number 4175. In one embodiment, merchant 480 matches serial number 4175 against datastore 460 to confirm that there is no matching return information 450 stored in datastore 460. Merchant 480 then stores return information 450 into datastore 460. Merchant 480 approves the return.

In one embodiment, merchant 480 connects to media player 420. Merchant 480 sends a removal command 459 to media player 420 to remove digital media 410. In one embodiment, removal command 459 includes product code 417.

Media player 420 receives removal command 459. In one embodiment, media player 420 includes a storage storing digital media 410; media player 420 removes digital media 410 from the storage. In one embodiment, media player 420 does not play digital media 410. In one embodiment, media player 420 modifies digital media 410 such that content 414 can no longer be played. In one embodiment, media player 420 remembers product code 417 and does not play any digital media 410 matching product code 417.

In one embodiment, media player 420 sends a confirmation to merchant 480, indicating that digital media 410 has been successfully removed.

Merchant 480 credits the purchase monetary amount for digital media 410 to customer 400. In one embodiment, merchant 480 generates a check for the purchase monetary amount and mails the check to customer 400, using the mailing address in customer information 455. In another embodiment, merchant 480 conducts an electronic fund transfer for the purchase monetary amount using credit card or bank account information in customer information 455.

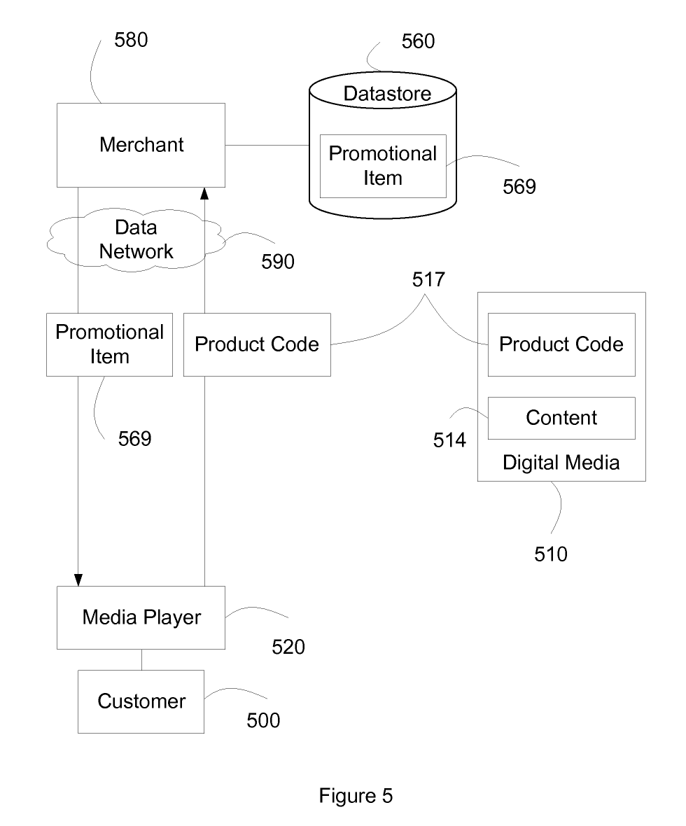

FIG. 5 illustrates a process to obtain a promotional item based on product code.

Digital media 510 includes product code 517 and content 514. After customer 500 purchases digital media 510 from merchant 580, customer 500 uses media player 520 to play digital media 510.

Media player 520 connects to merchant 580 over data network 590 and sends product code 517 to merchant 580.

Merchant 580 includes datastore 560. Datastore 560 includes promotional item 569 associated with product code 517. In one embodiment, promotional item 569 includes video content, audio content, or an image. In one embodiment, promotional item 569 includes an autographed photo, a poster, or a music video of an artist for digital media 510. In one embodiment, promotional item 569 includes a newly released song by the artist, or a segment of the song. In one embodiment, promotional item 569 includes a discount coupon. Merchant 580 retrieves promotional item 569 from datastore 560 using product code 517. Merchant 580 sends promotional item 569 to media player 520.

In one embodiment, media player 520 displays promotion item 569 on a display screen. In one embodiment, media player 520 displays promotional item 569 while playing content 514. In one embodiment, media player 520 displays promotional item 569 at a later time. In one embodiment, media player 520 connects to a storage and stores promotional item 569 in the storage. In one embodiment, media player 520 prints promotional item 569 using a printer. In one embodiment, media player 520 plays video and audio content of promotion item 569.

In one embodiment, promotional item 569 is a luck draw or lottery. Media player 520 sends product code 517 to merchant 580 in order to enter a luck draw or lottery. In one embodiment, media player 520 sends a plurality of product codes to redeem promotion item 569.

In one embodiment, customer 500 sends product code 517 to redeem promotion item 569 through email or mail.

In the above embodiments, merchants 180, 280, 380, 480 and 580 may comprise a controller for communicating over a data network, for sending and receiving digital media comprising digital media product codes, for accessing a datastore, for processing digital media product codes, for processing digital media purchases, returns, rebates, and promotional items, and/or for other steps described above in the respective embodiments. A controller may comprise any computer, processor, or device capable of performing said steps.

While certain exemplary embodiments have been described and shown in the accompanying drawings, it is to be understood that such embodiments are merely illustrative and not restrictive of the broad invention and that this invention is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure or the scope of the accompanying claims.

1. A method for processing digital media, comprising:
sending a piece of digital media, purchased by a customer, to the customer, wherein the piece of digital media is for playing on a media player; and
receiving from the customer a piece of information associated with the piece of digital media;
wherein the piece of digital media comprises a digital media product code.

2. The method of claim 1, the piece of digital media comprising (a) audio content representing one or more songs, pieces of music or movie sound tracks, (b) video content representing one or more movies, television programs or music videos, or (c) image content representing one or more photos, pictures or images.

3. The method of claim 1, wherein the digital media product code comprises a sequence of digits, a sequence of characters, a stacked barcode or a matrix barcode.

4. The method of claim 3, wherein the digital media product code comprises a serial number.

5. The method of claim 1, wherein the piece of information comprises registration information, the registration information comprising (a) the digital media product code, and (b) customer information, the method further comprising:
matching the received digital media product code against a plurality of product codes; and
storing the registration information as a registration record.

6. The method of claim 5, wherein the receiving comprises receiving the registration information from a media player of the customer.

7. The method of claim 1, wherein the piece of information comprises rebate information, the rebate information comprising the digital media product code and customer information.

8. The method of claim 7, wherein the customer information comprises one or more of customer name, customer mailing address, date of purchase, credit card information, and bank account information.

9. The method of claim 7, wherein the receiving comprises receiving the rebate information from a media player of the customer.

10. The method of claim 8, further comprising:
delivering a rebate monetary amount to the customer.

11. The method of claim 1, wherein the piece of information comprises return information, the return information comprising the digital media product code and customer information.

12. The method of claim 11, wherein the receiving comprises receiving the return information from a media player of the customer.

13. The method of claim 12, further comprising:
sending a removal command to the media player of the customer; and
removing the piece of digital media.

14. A method for processing digital media, comprising:
receiving a purchased piece of digital media from a merchant over a data network, the piece of digital media for playing on a media player; and
displaying by the media player a digital media product code wherein the piece of digital media comprises the digital media product code.

15. The method of claim 14, the piece of digital media comprising (a) audio content representing one or more songs, pieces of music or movie sound tracks, (b) video content representing one or more movies, television programs or music videos, or (c) image content representing one or more photos, pictures or images.

16. The method of claim 14, wherein the digital media product code comprises a sequence of digits, a sequence of characters, a stacked barcode or a matrix barcode.

17. The method of claim 16, wherein the digital media product code comprises a serial number.

18. The method of claim 14, wherein the displaying comprises:
printing the digital media product code as a proof of purchase.

19. A system for processing digital media, comprising:
a storage element to store a plurality of digital media product codes; and
a controller to:
send a piece of digital media, purchased by a customer, to the customer, wherein the piece of digital media is for playing on a media player; and
receive from the customer a piece of information associated with the piece of digital media;
wherein the piece of digital media comprises a digital media product code.

20. The system of claim 19, the piece of digital media comprising (a) audio content representing one or more songs, pieces of music or movie sound tracks, (b) video content representing one or more movies, television programs or music videos, or (c) image content representing one or more photos, pictures or images.

21. The system of claim 19, wherein the piece of information comprises digital media registration information, the registration information comprising (a) the digital media product code indicating purchase of the piece of digital media by the customer, and (b) customer information, the controller further to:
match the received digital media product code against the plurality of product codes; and
store the customer's digital media registration information as a registration record.

22. The system of claim 19, wherein the piece of information comprises rebate information, the rebate information comprising the digital media product code and customer information, the controller further to:
deliver a rebate monetary amount to the customer.

23. The system of claim 19, wherein the piece of information comprises return information, the return information comprising the digital media product code and customer information, the controller further to:
send a removal command to a media player of the customer.
